(19) United States
(12) Patent Application Publication
(10) Pub. No.: US 2019/0193987 A1
(43) Pub. Date: Jun. 27, 2019

(54) CALL DEVICE FOR ELEVATOR SYSTEM

(71) Applicant: KONE Corporation, Helsinki (FI)

(72) Inventors: Eero PUTKINEN, Helsinki (FI); Toni TOIVANEN, Helsinki (FI); Matti NAAPURI, Helsinki (FI); Jari ANTTILA, Helsinki (FI)

(73) Assignee: KONE Corporation, Helsinki (FI)

(21) Appl. No.: 16/203,303

(22) Filed: Nov. 28, 2018

(30) Foreign Application Priority Data
Dec. 22, 2017 (EP) 17210076.0

(51) Int. Cl. B66B 1/46; B66B 1/30

(52) U.S. Cl. CPC B66B 1/46; B66B 1/30

(57) ABSTRACT

An elevator call device includes: a processing unit for controlling a generation of an elevator call; an energy storage for storing electrical energy; a coupler for obtaining electrical energy from an external source for charging the energy storage, and a switch controllable with a call indicator device for activating the processing unit to generate the elevator call signal with the electrical energy from the energy storage. Further, a method for generating an elevator call is disclosed.

### TECHNICAL FIELD

The invention concerns in general the technical field of elevators. More particularly, the invention concerns elevator call device.

### BACKGROUND

Elevator calling is typically arranged so that a call device, such a call button, is arranged in a hall from where passengers enter an elevator car. A typical location of the call device is a wall next to elevator doors. The call device is communicatively coupled to an elevator control device, aka elevator controller, which is an entity taking care of at least some control operations of the elevator system. Among others, the elevator control device is configured to receive elevator calls from the call device and to generate control signals, such as control signals for a hoisting device, in order to instruct the elevator car to move. Naturally, the control device is provided with electricity through applicable power wiring.

As may be seen from the short description above an implementation of the call device system in the elevator system requires wiring and especially in modernization situations, in which an elevator is to be installed in an old building, the wiring may turn out to be challenging, expensive and time-consuming.

To solve the above-mentioned challenges some prior art solutions are introduced. For example, a document WO 2007/030109 discloses an arrangement in which a wireless call button is introduced. The wireless call button is configured to transmit a unique wireless signal when a passenger presses a call button for indicating a need for elevator service. The call button is also implemented so that it does not require wiring for bringing power to the call button, but the power generation is arranged with a piezo electric power generator in the call button. In other words, when the passenger presses the button the piezo electric power generator generates the power for the other modules in the call device, such as for wireless transmitter to transmit the call signal.

The drawback with the known solutions are that they are not reliable to use, and it may turn out that the pushing of the button does not generate enough energy for performing the desired task.

Hence, there is need to develop further solutions in the area.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An objective of the invention is to present an elevator call device for generating an elevator call signal. Another objective of the invention is that the elevator call device is configured to operate in a wireless manner at least in part.

The objectives of the invention are reached by an elevator call device as defined by the respective independent claims.

According to a first aspect, an elevator call device is provided, the elevator call device comprising: a processing unit for controlling a generation of an elevator call; an energy storage for storing electrical energy; a coupler for obtaining electrical energy from an external source for charging the energy storage; and a switch controllable with a call indicator device for activating the processing unit to generate the elevator call signal with the electrical energy from the energy storage.

The coupler may be configured to obtain the electrical energy from the external source through one of the following: galvanic connection, inductive connection.

The external source may be one of the following: power cable providing power to an elevator car, a battery carried by the elevator car, a generator generating electrical energy from a kinetic energy of at least one door of the elevator car, a generator generating electrical energy from a kinetic energy of the elevator car, an inductive loop arranged between the elevator car and an entity electrically coupled to the energy storage.

The elevator call device may further comprise a communication module, wherein the activation of the processing unit is configured cause a transmit of the generated elevator call signal by the communication module.

Moreover, the energy storage may be a capacitor unit comprising at least one supercapacitor.

According to a second aspect, a method for generating an elevator call signal with an elevator call device is provided, wherein the elevator call device comprising: a processing unit, an energy storage for storing electrical energy, a coupler for obtaining electrical energy from an external source for charging the energy storage, and a switch, wherein the method comprises: activating the processing unit to generate the elevator call signal with the electrical energy from the energy storage in response to a control of the switch with the call indicator device.

In the method, the electrical energy may be obtained, by the coupler, from the external source through one of the following: galvanic connection, inductive connection.

Moreover, the method may comprise transmitting the generated elevator call signal by a communication module of the elevator call device in response to the activation of the processing unit.

The expression “a number of” refers herein to any positive integer starting from one, e.g. to one, two, or three.

The expression “a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an example of an elevator system into which the present invention may be implemented to.

FIG. 2 illustrates schematically an example of a call device according to an embodiment of the invention.

FIG. 3 illustrates schematically an example of an implementation for charging an energy storage of a call device.

FIG. 4 illustrates schematically a further example of the invention according to an embodiment.

FIG. 5 illustrates schematically an example of a method according to an embodiment of the invention.

### DESCRIPTION OF THE EXEMPLIFYING EMBODIMENTS

The specific examples provided in the description given below should not be construed as limiting the scope and/or the applicability of the appended claims.

Lists and groups of examples provided in the description given below are not exhaustive unless otherwise explicitly stated.

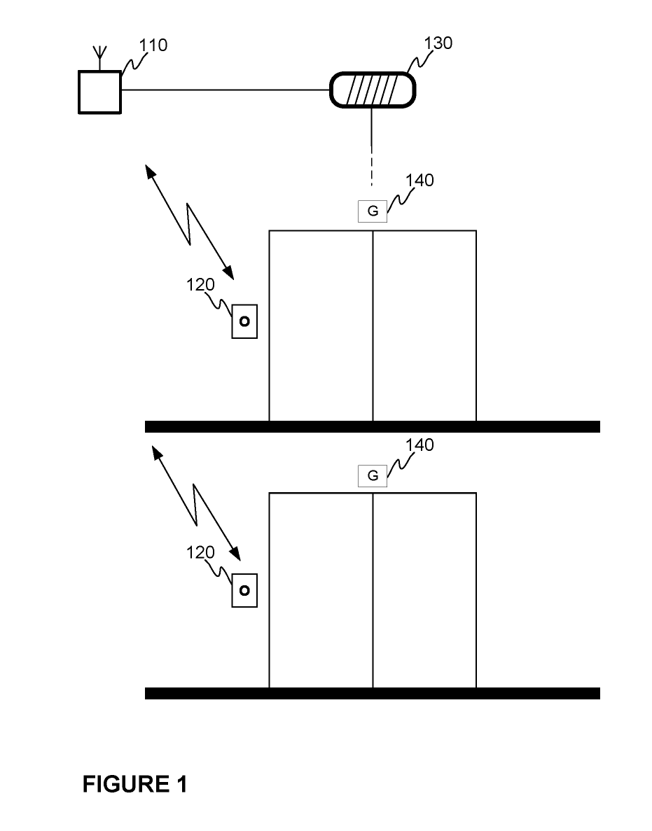

FIG. 1 schematically illustrates an example of an elevator system into which the present invention may be implemented to. The elevator system is implemented for carrying passengers from one floor to another in a space the elevator system is implemented to. In the exemplifying FIG. 1 a number of the floors is two. The elevator system may comprise an elevator control device 110 which may be communicatively coupled to one or more other entities, such as to an elevator call device 120 residing e.g. on every floor, a hoisting machine 130, hall display 140, and so on for communicating with the other entities. Some non-limiting examples of the communication between the entities may e.g. be control signals instructing an entity to perform a certain task or data acquisition signals for obtaining e.g. measurement data from one or more sensors. The communicative coupling between the elevator control device 110 and the call device 120 according to the present invention is implemented in a wireless manner. The wireless communication technology used in this context may be any applicable short-range communication technology, such as Wi-Fi, or wide-area communication technology, such as a technology utilizing mobile communication network having a coverage within the area of the elevator. Moreover, the call device 120 may be implemented so that it comprises an energy storage which may be charged from external entity as will be discussed. The energy storage refers to an electrical component, or a plurality of those, for example. The electrical component may e.g. be a capacitor, such as a so-called supercapacitor, as a non-limiting example. All in all, the present invention enables an implementation of the elevator call device in a wireless manner as a whole or at least in part.

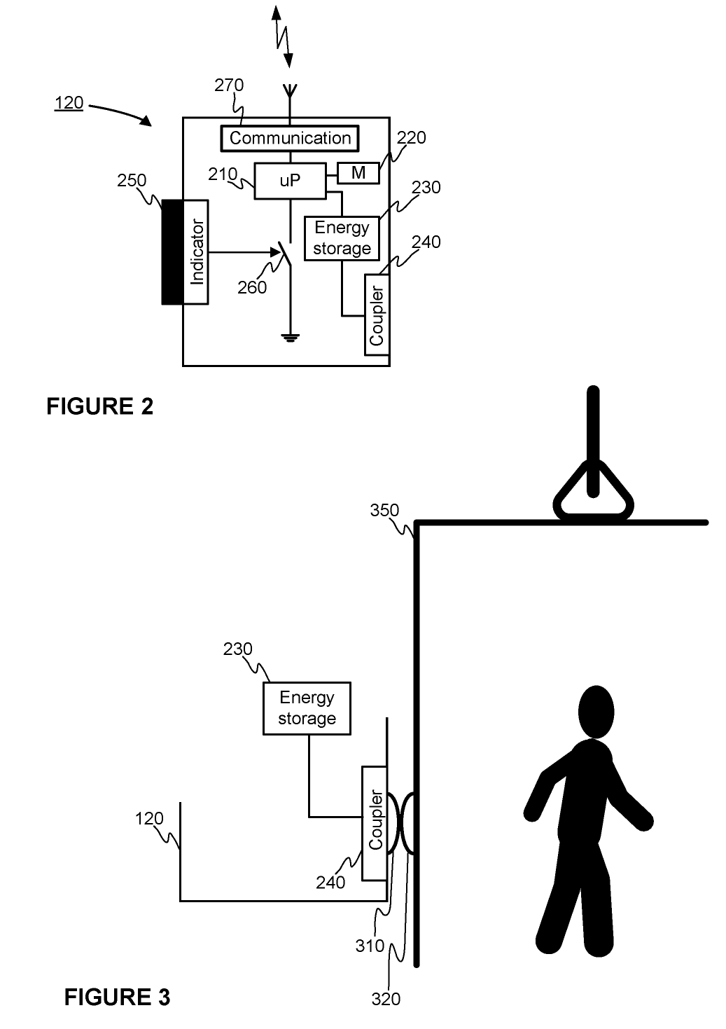

FIG. 2 illustrates an example of the call device 120 according to an embodiment of the invention. The example shown in FIG. 2 does not necessarily illustrate all necessary components and elements need to implement the call device 120 as a whole, but at least those entities are disclosed, which are needed to describe at least some aspects of the present invention. In the embodiment as disclosed in FIG. 2 the call device 120 comprises a processing unit 210 including one or more processors for controlling at least some operations of the call device 120, when the processing unit 210 is configured to execute at least one portion of a computer program code. The processing unit 210 may be communicatively coupled to memory unit 220 storing data, such as computer program code, parameters and data input and output thereto and therefrom. The memory unit 220 may include one or more memory elements of any suitable type for storing the data, as mentioned. The call device 120 according to the embodiment comprises an internal energy storage 230 which may be charged from an external energy source to the call device 120. According to the embodiment the energy storage 230 may be charged by means of a coupler 240. The coupler 240 shall be understood as a device, which provides means for obtaining electrical energy from external energy source either directly or indirectly e.g. through an interaction between the coupler 240 and an external device to the call device 120. The energy stored in the energy storage 230 may be provided to the processing unit 210. The processing unit 210 may be activated, for example, in response to a call indication given by a passenger through a call indicator device 250, which may e.g. be a push button. In other words, in response to a receipt of the indication, i.e. an elevator call, the call indicator device 250 may be configured to control a switch so that when the call is given the switch 260 electrically connects the processing unit 210 to a ground for activating an operation of the processing unit 210, and hence the call device 120. In other words, the processing unit 210 wakes up in response call indication, and is configured to perform so that the elevator call may be delivered to an elevator control device 110. For example, the processing unit 210 may be configured to generate a call signal and instruct a communication module 270 to transmit the call signal to the elevator control device 110 e.g. through an antenna. The communication module 270 may e.g. be a modem implementing a wireless communication technology, such as Wi-Fi. Preferably, it is a low energy device in the context of the present invention. Alternatively or in addition, the communication module 270 may perform the communication in a wired manner in case the elevator environment supports the wired communication i.e. the necessary wiring is in place.

As discussed above an activation of the call indicator device 250 e.g. by a passenger causes a discharging of the energy storage 230 at least in part so that the processing unit 210, in the described embodiment, wakes up from a sleep or idle mode. The processing unit 210 may be configured so that the activation causes the processing unit 210 to operate in a predetermined manner, i.e. so that an elevator call signal is generated and delivered to the elevator control device 110 through the communication module 270. The communication module 270 is at least configured to transmit generated signals, but in some embodiment of the invention the communication module 270 may also implement a functionality of a receiver, if two-way communication is implemented in the call device 120.

According to some embodiment of the invention the processing unit 210 may be configured to monitor charging level of the energy storage 230. This may be implemented so that the processing unit 210 may e.g. utilize an electrical energy of the energy storage 230 for performing the monitoring function. The monitoring function may be implemented as a watchdog functionality i.e. the processing unit 210 may be configured to generate an inquiry to the energy storage for obtaining data representing energy level of the energy storage 230 under a predetermined scheme, based e.g. on time. In response to a detection that the energy level of the energy storage is below a reference level, the processing unit 210 may be configured to perform an action to cause the charging of the energy storage. As discussed above, the action to cause the charging may e.g. be that electrical energy is obtained from external energy source either directly or indirectly e.g. through an interaction between the coupler 240 and an external device to the call device 120. An example of the action to cause the charging may e.g. be a generation of an elevator call when the electrical energy for charging is obtained from the elevator car, for example.

Next some aspects relating to the energy storage 230 and its charging are discussed. Firstly, in some embodiment of the invention the energy storage 230 is advantageously a capacitor unit comprising one or more capacitors. The capacitors in the capacitor unit may e.g. be so called supercapacitors, which have an advantage that they have high energy density and their charging and discharging is fast. Additionally, they tolerate high number of charging and discharging cycles which is advantageous feature in the application environment of the present invention.

Next some non-limiting examples with respect to charging of the energy storage, such as the capacitor unit comprising one or more supercapacitors, are discussed. As mentioned the elevator call device 120 comprises a coupler 240 which comprises means for obtaining electrical energy from external energy source either directly or indirectly e.g. through an interaction between the coupler 240 and an external device to the call device 120. According to a first non-limiting example the coupler 240 may be implemented so that it provides a port 310 for charging the energy storage 230 from an external entity. In the example of FIG. 3 the external entity is an elevator car 350, which may be equipped with a counter-port 320 to the port 310 of the coupler 240. According to an embodiment the ports 310, 320 may be configured to form a galvanic connection, and in that manner to establish a conductive path from the elevator car 350 to the energy storage 230 through the coupler 240. The embodiment shown in FIG. 3 enables the charging of the energy storage 230 from a power of the elevator car 350. The power of the elevator car 350 may e.g. be brought in with the hoisting system e.g. so that a power cable is arranged to provide the electricity to the elevator car 350, which electricity may be conveyed to the energy storage 230 in the described manner. Alternatively or in addition, the elevator car 350 may carry a power source, such as a battery, which may be charged in an elevator shaft. The power source may provide the energy to the energy storage 230 when the ports 310, 320 are conductively coupled to each other. The conductive coupling may e.g. be established e.g. at landing i.e. when the elevator car arrives to at least one floor and stops there. The ports 310, 320 are adjusted to contact each other during the stop and the energy storage 230 may be charged. The ports 310, 320 may be of any type which may establish the conductive path as described. In some implementation they may have flexible character in order enable a smooth arrival of the elevator car, and, thus, an establishment of the conductive path between the port 310 and the counter-port 320. As mentioned the ports may establish the conductive path with a galvanic connection, but in some embodiment of the invention the connection may be implemented with an inductive coupling.

According to another embodiment the energy storage 230 may be charged by changing a kinetic energy generated by the elevator system, or any applicable external energy source, to an electrical energy. The source of the kinetic energy may e.g. be any moving entity in the elevator system into which a suitable generator device is installed. An example of the source may be elevator door or doors, which are typically opened and closed when the elevator car arrives at a floor level. By installing the generator device within the door frame so that the kinetic energy generated by the opening or closing motion of the door may be collected and converted to an electrical energy it is possible to be conveyed to the energy storage 230 accordingly. For example, the generator device may be wired so that it forms a conductive path to the energy storage 230 through the coupler 240 by utilizing the port 310 and the counter-port 320 when the elevator car arrives at the floor in question.

Moreover, the kinetic energy transformed to electrical energy may also originate from an external source to the elevator system. For example, the external source may be any device or system within the building in which the elevator is installed to. For example, the kinetic energy may be obtained from doors of the building, other people flow systems, such as escalators in the building in question, and so on.

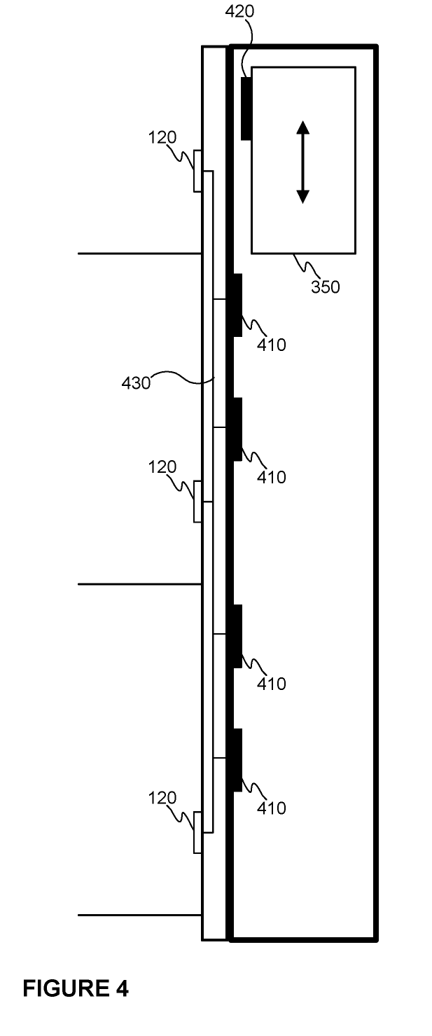

According to another embodiment of the present invention the kinetic energy may origin from a motion of the elevator car 350 in an elevator shaft. An example of such an arrangement is schematically illustrated in FIG. 4. Since the elevator car travels in the elevator shaft a known route it is possible to arrange a generation of an electrical energy from the kinetic energy of the elevator car 350. This kind of implementation may be achieved with such an elevator system into which a number of generator devices is arranged so that the electrical energy may be generated from the kinetic energy of the elevator car 350 with an interaction of at least one first generator element 410 and at least one second generator element 420. The at least one first generator element 410 may be mounted in the elevator shaft, whereas the at least one second generator element 420 is mounted on an outer wall of the elevator car 350 so that the first and the second generator element may interact together for generating the electrical energy when the elevator car 350 travels in the shaft. For example, the first generator entity may e.g. be based on a rotating wheel mounted to a guide rail of the elevator, which rotating wheel is configured to touch the elevator car, i.e. the second generator element 420 when the elevator car 350 passes by the wheel. The wheel causes the generation of the electricity e.g. in a dynamo-like manner, which electricity may be conveyed to the energy storage 230. The at least one first generator element 410 may be coupled either directly or indirectly, e.g. through another circuit, or the coupler, to one or more call devices 120 residing in a hall with an applicable wiring 120. Hence, in response to the motion of the elevator car 350 in the shaft electricity may be generated by the generator device and the generated electricity may be conveyed to the energy storage 230 of the call device 120. In some preferred embodiments of the invention the first generator element 410 is advantageously implemented in the call device 120 so that there is no need to establish the wiring 430 in the elevator system. In such an embodiment a call device assembly and mounting may be implemented so that the backside of the call device 120 comprises the first generator element 410, which backside extends to the elevator shaft so that the interaction between the first generator element 410 and the second generator element 420 may be achieved in at least some position of the elevator car 350 in the elevator shaft.

A further non-limiting example of the invention may be that the electrical energy is generated by means of inductive coupling. For example, the elevator shaft may be equipped with one or more coils, whereas the elevator car 350 is equipped with magnets. Now, when the magnets residing e.g. on an outer wall of the elevator car 350 passes by the coil, a current is induced in the coil and it may be conveyed to the energy storage 230. The magnet, or a plurality of magnets, may e.g. be permanent magnets, for example. The inductive coupling is especially applicable when the elevator car 350 is parked on a position for charging for a period of time being enough for inductively charging the energy storage 230.

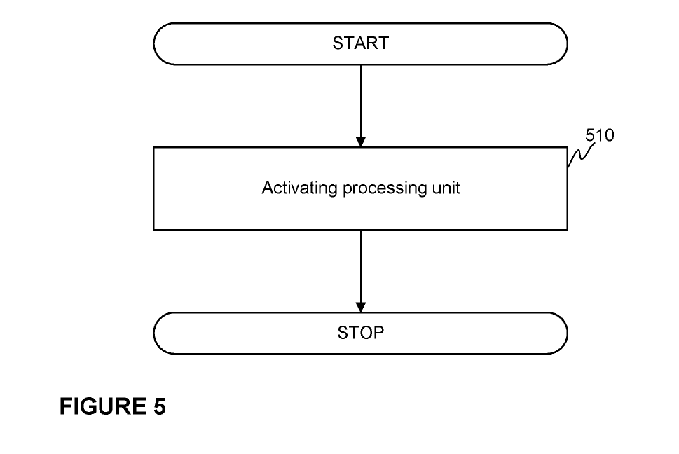

FIG. 5 schematically illustrates a method according to the present invention. The method may be implemented by an elevator call device 120 as described above, which may be configured to interact with one or more external entities as described. In the method an elevator call signal may be generated with the elevator call device 120 so that a processing unit 210 may be activated 510 to generate the elevator call signal with the electrical energy from the energy storage 230 in response to a control of the switch 260 with the call indicator device 250. The electrical energy may be obtained, by the coupler 240 or with the coupler 240, from the external source through one of the following: galvanic connection, inductive connection. Further, the method may comprise a step in which the generated elevator call signal is transmitted, by a communication module 270 of the elevator call device 120, in response to the activation of the processing unit 210.

In the description of at least some embodiments of the invention it is mainly referred to an implementation wherein the call indicator device 250 is a push button controlling the switch 260. However, the present invention is not limited to such a call indicator device 250 only, but any similar call indicator device 250 may be used, which may generate a signal for controlling a discharge of the energy storage 230 in response to a generation of elevator call. Some non-limiting examples of the call indicator device 250 may be sensors, such as a camera or a microphone, configured to trigger an elevator call in response to a detection of a predetermined event, such as a person attending in a certain area.

Further, the implementation of the present invention may be arranged so that the call indicator device 250, when applicable, is configured to obtain electrical energy from the energy storage 230. This may be necessary if it is desired that the call indicator device 250 is e.g. illuminated for being better visible in dark. This kind of arrangement may be established with a design of the elevator call device and the circuitry therein. Naturally, the powering of the call indicator device 250 is implementation specific, and in case the call indicator device 250 is required to be active, such as is the case with camera, the powering of the device is a necessity.

Having a wireless call device according to the present invention gives a freedom to mount the call device in an optimal location because there is no need to take into account wiring aspects of the elevator system. This may improve user satisfaction with respect to elevator usage.

The specific examples provided in the description given above should not be construed as limiting the applicability and/or the interpretation of the appended claims. Lists and groups of examples provided in the description given above are not exhaustive unless otherwise explicitly stated.

1. An elevator call device comprising:
a processing unit for controlling a generation of an elevator call;
an energy storage for storing electrical energy;
a coupler for obtaining electrical energy from an external source for charging the energy storage; and
a switch controllable with a call indicator device for activating the processing unit to generate the elevator call signal with the electrical energy from the energy storage.

2. The elevator call device of claim 1, wherein the coupler is configured to obtain the electrical energy from the external source through one of the following: galvanic connection, inductive connection.

3. The elevator call device of claim 1, wherein the external source is one of the following: power cable providing power to an elevator car, a battery carried by the elevator car, a generator generating electrical energy from a kinetic energy of at least one door of the elevator car, a generator generating electrical energy from a kinetic energy of the elevator car, an inductive loop arranged between the elevator car and an entity electrically coupled to the energy storage.

4. The elevator call device of claim 1, the elevator call device further comprising a communication module, wherein the activation of the processing unit is configured cause a transmit of the generated elevator call signal by the communication module.

5. The elevator call device of claim 1, wherein the energy storage is a capacitor unit comprising at least one supercapacitor.

6. A method for generating an elevator call signal with an elevator call device comprising:
a processing unit;
an energy storage for storing electrical energy;
a coupler for obtaining electrical energy from an external source for charging the energy storage; and
a switch,
wherein the method comprises activating the processing unit to generate the elevator call signal with the electrical energy from the energy storage in response to a control of the switch with the call indicator device.

7. The method of claim 6, wherein the electrical energy is obtained, by the coupler, from the external source through one of the following: galvanic connection, inductive connection.

8. The method of claim 6, wherein the method comprises transmitting the generated elevator call signal by a communication module of the elevator call device in response to the activation of the processing unit.

9. The elevator call device of claim 2, wherein the external source is one of the following: power cable providing power to an elevator car, a battery carried by the elevator car, a generator generating electrical energy from a kinetic energy of at least one door of the elevator car, a generator generating electrical energy from a kinetic energy of the elevator car, an inductive loop arranged between the elevator car and an entity electrically coupled to the energy storage.

10. The elevator call device of claim 2, the elevator call device further comprising a communication module, wherein the activation of the processing unit is configured cause a transmit of the generated elevator call signal by the communication module.

11. The elevator call device of claim 3, the elevator call device further comprising a communication module, wherein the activation of the processing unit is configured cause a transmit of the generated elevator call signal by the communication module.

12. The elevator call device of claim 2, wherein the energy storage is a capacitor unit comprising at least one supercapacitor.

13. The elevator call device of claim 3, wherein the energy storage is a capacitor unit comprising at least one supercapacitor.

14. The elevator call device of claim 4, wherein the energy storage is a capacitor unit comprising at least one supercapacitor.

15. The method of claim 7, wherein the method comprises transmitting the generated elevator call signal by a communication module of the elevator call device in response to the activation of the processing unit.
